(19) United States
(12) Patent Application Publication
(10) Pub. No.: US 2013/0235084 A1
(43) Pub. Date: Sep. 12, 2013

(54) MULTI-SOURCE MULTIPLE DOCUMENTS COMPARISON DISPLAY (PRESENTATION OR DISCUSSION) SYSTEM

(71) Applicants: Chuan-Wei WU, Taipei City (TW); Jen-Kai Liang, Taipei City (TW)

(72) Inventors: Chuan-Wei WU, Taipei City (TW); Jen-Kai Liang, Taipei City (TW)

(21) Appl. No.: 13/418,187

(22) Filed: Mar. 12, 2012

(51) Int. Cl. G09G 5/00

(52) U.S. Cl. 345/660

(57) ABSTRACT

A multi-source, multiple documents comparison display system for presentation or discussion, installed in a host computer and displayed on a public screen as a multiple document comparison interface using the computer's auxiliary display system. The system is divided into a document collection stage and a comparison display stage. The document collection stage receives documents from multiple resources and decides the number of multiple quadrants to be arranged via the multiple documents comparison interface. The comparison display stage displays each document as a thumbnail, and allows any document to be enlarged and inspected with a control button by clicking on the thumbnail corresponding to the desired document.

### BACKGROUND OF THE INVENTION

1. Field of the Invention

The present invention is a multi-source, multiple document comparison display system for presentation or discussion, which is installed in a host computer and displayed on a public screen as a multiple document comparison interface using the computer's auxiliary display system.

2. Description of the Prior Art

In recent years, different types of application equipment and software have emerged due to rapidly developing network technologies and high transmission rates. With conventional systems gradually being replaced by interactive technologies such as the Internet and computer equipment, a conventional projector for documents projected to and displayed by a single projective machine is limited in its usage, and provides neither interactional functions nor real-time connection to another device. Such a conventional projector system or device also fails to provide a simultaneous display of related information.

A conventional projector system or device is an inconvenient tool which fails to promote interaction or coordinate networks simultaneously and is unfavorable with regard to data being updated or downloaded directly thereto, so that any new, updated version of software must be downloaded to a private computer first and hence requires extra time or work.

### SUMMARY OF THE INVENTION

The object of the present invention is to provide one multi-source, multiple document comparison display system for presentation or discussion as a computer's auxiliary display system. The system is installed in a host computer (Host) for connecting clients, and the multiple document comparison interface system is immediately displayed on a public screen.

Another object of the present invention is to provide a multi-source multiple document comparison display system for presentation or discussion with a document collection stage and a comparison display stage, which includes the following stages:

(1) Document collection stage: The comparison interface is selectively split to and arranged as a number of different quadrants and displayed according to multiple documents. The documents may be transmitted from different mobile sources, devices or carriers via a cable network or a wireless network with the multi-source multiple documents comparison display system for presentation or discussion being activated by a host computer (Host);

(2) Comparison display stage: The distinct thumbnails for compressed documents are arranged and displayed on a public screen and provided with control buttons, each of which can be clicked to check one document's content individually.

The data transfer devices which facilitate multiple and real-time sources of documents comprise:

Document Camera (DC) providing immediately shot data such as a document and an object;

Tablet personal computer (PAD) or notebook computer for documents or data in any page being immediately transported to a host computer via a cable network or a Wireless Local Area Network;

Smartphone providing real-time data via a Wireless Local Area Network; and

Mobile device used to transport documents or data which can be received by a host computer and displayed on a public screen.

A further object of the present invention is to label information which is necessary to document comparison or presentation on a document in the system, and simultaneously offer a user's mobile device (or host computer) a mechanism of real-time voting.

These features and advantages of the present invention will be fully understood and appreciated from the following detailed description of the accompanying Drawings.

### DETAILED DESCRIPTION OF THE PREFERRED EMBODIMENT

FIG. 1 is a schematic illumination for a multi-source, multiple document comparison display system for presentation or discussion of the present invention. The system is composed of a Document Camera (DC) 2, a host computer (Host) 3, and a public screen 4, wherein the Document Camera (DC) 2 is used to input image information of a scanned document or object 1 into the host computer 3 for corresponding video output of the host computer 3 displayed on the public screen 4. The host computer (Host) 3 links a Wireless Local Area Network (WLAN) 5 via a cable network or a Wireless Local Area Network in order to receive documents or data transmitted among mobile devices such as a Smartphone 6, tablet personal computer 7, and notebook computer 8, and votes through a Wireless Local Area Network.

FIG. 2 is a flowchart for a multi-source, multiple document comparison display system for presentation or discussion which shows, in sequence: (a) Task designation initiated by the host computer (Host) 100; (b) Task designated by the host computer (Host) 101; (c) Display, presentation or discussion mode activated by the host computer (Host) 102; (d) Number of multiple quadrants decided by the system of the host computer (Host) 103; (e) Connection to a Wireless Local Area Network (WLAN) for documents or data input by a Client's cell phone 104, documents or data transmitted by a Client's tablet personal computer (PAD) or notebook computer 105, or documents or data input by the host computer (Host) based on the Document Camera (DC) 106, which is capable of scanning substantial objects for scanned image-based documents or data exported to the host computer (Host); (f) Document-related data signals transmitted to the host computer (Host) from all Clients' mobile devices or Document Cameras (DC) and simultaneously displayed as split thumbnails with their resources remarked 107; (g) Number of multiple quadrants to be displayed decided by the host computer (Host) 108 (otherwise documents or data re-transmitted in case of any error during transmission of such documents or data or indetermination of the number of multiple quadrants to be displayed); (h) All documents or data integrated in a new page by the system and displayed in multiple quadrants on a public screen with documents conclusively transmitted 109.

FIG. 3 illustrates a flowchart describing multiple thumbnails to be zoomed in/out for the present invention of a multi-source, multiple document comparison display system for presentation or discussion. As shown in FIG. 2, image-based documents and objects transmitted to the host computer (Host) can be viewed by one user with a new page based on multiple quadrants 200 created wherein the new page based on multiple quadrants 200 comprises several functions as follows: multiple thumbnails inspection mode 202, fast zoom in/out of images in multiple quadrants 203, zoom in of a single image 204, and zoom out of a single image 205. Furthermore, the IRS (Interactive Response System) function for vote 201 is intended for voting image-based documents or objects through the page based on multiple quadrants 200 on a public screen in a manner of using Clients' mobile devices and the host computer (Host) connected via a cable network or a wireless network.

FIG. 4 is a schematic illustration describing selection of multiple quadrants for the present invention of a multi-source, multiple document comparison display system for presentation or discussion. Multiple quadrants can be selectively arranged on a public screen which is divided into two quadrants, four quadrants, six quadrants, eight quadrants, nine quadrants, ten quadrants, or twelve quadrants.

FIG. 5 is a schematic illustration of four quadrants for the present invention of a multi-source, multiple document comparison display system for presentation or discussion wherein four thumbnails indicating image-based documents (or objects) and data sources are transmitted by Clients and renewed to a new page for initiation of the comparison stage with a decision made.

FIG. 6 is a schematic illustration explaining four quadrants for the present invention of a multi-source, multiple document comparison display system for presentation or discussion, wherein some footnotes or comments are remarked on the public screen by one user during the comparison stage.

FIG. 7 is a schematic illustration indicating multiple quadrants (four quadrants hereinafter) for the present invention of a multi-source, multiple document comparison display system for presentation or discussion. For the four quadrants shown on a public screen, each single thumbnail can be zoomed in by means of a control button.

FIG. 8 is a schematic illustration indicating a single enlarged thumbnail for the present invention of a multi-source, multiple document comparison display system for presentation or discussion, wherein the single enlarged thumbnail allows an imaged-based document or object to be clearly indicated on a public screen and four quadrants, including the said single thumbnail, are resumed with a corresponding control button clicked once.

FIG. 9 is a schematic illumination indicating a vote based on multiple quadrants for the present invention of a multi-source, multiple document comparison display system for presentation or discussion. For implementation of an IRS function for vote, any determination related to the vote should be received by the host computer (Host) which links the Clients' mobile devices via a Wireless Local Area Network for the statistics indicated on the screen.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

### BRIEF DESCRIPTION OF THE DRAWINGS

FIG. 1 is a schematic illustration showing the multi-source, multiple document comparison display system for presentation or discussion of the present invention;

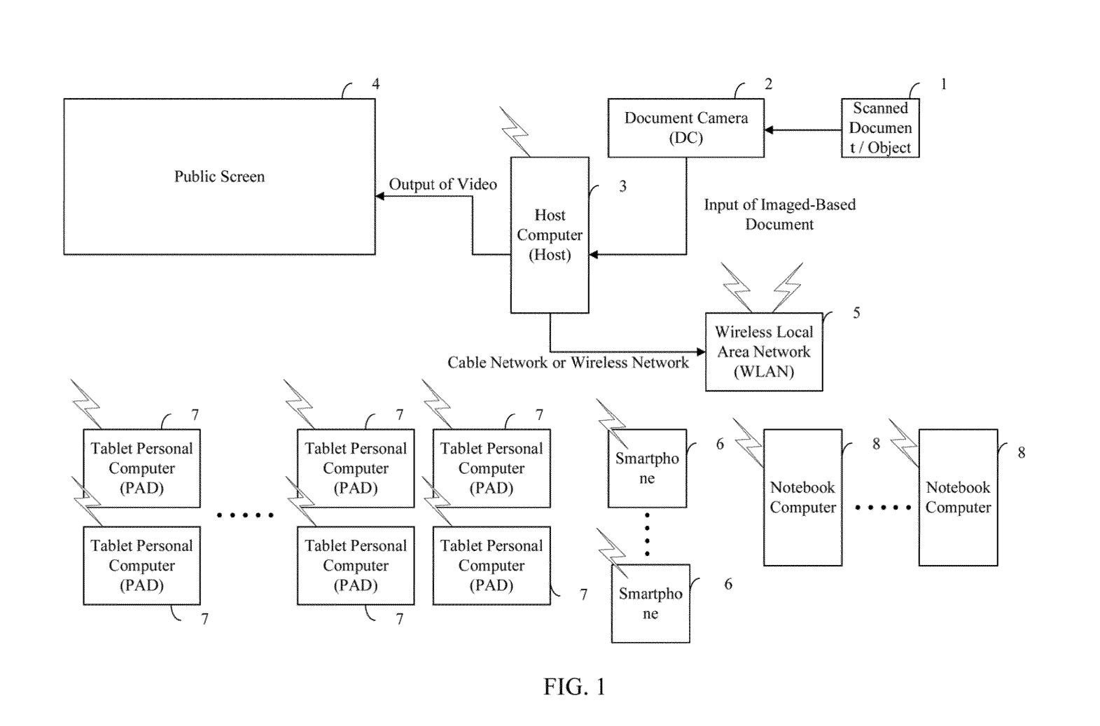

FIG. 2 is a flowchart showing multi-source, multiple document comparison display system for presentation or discussion of the present invention;

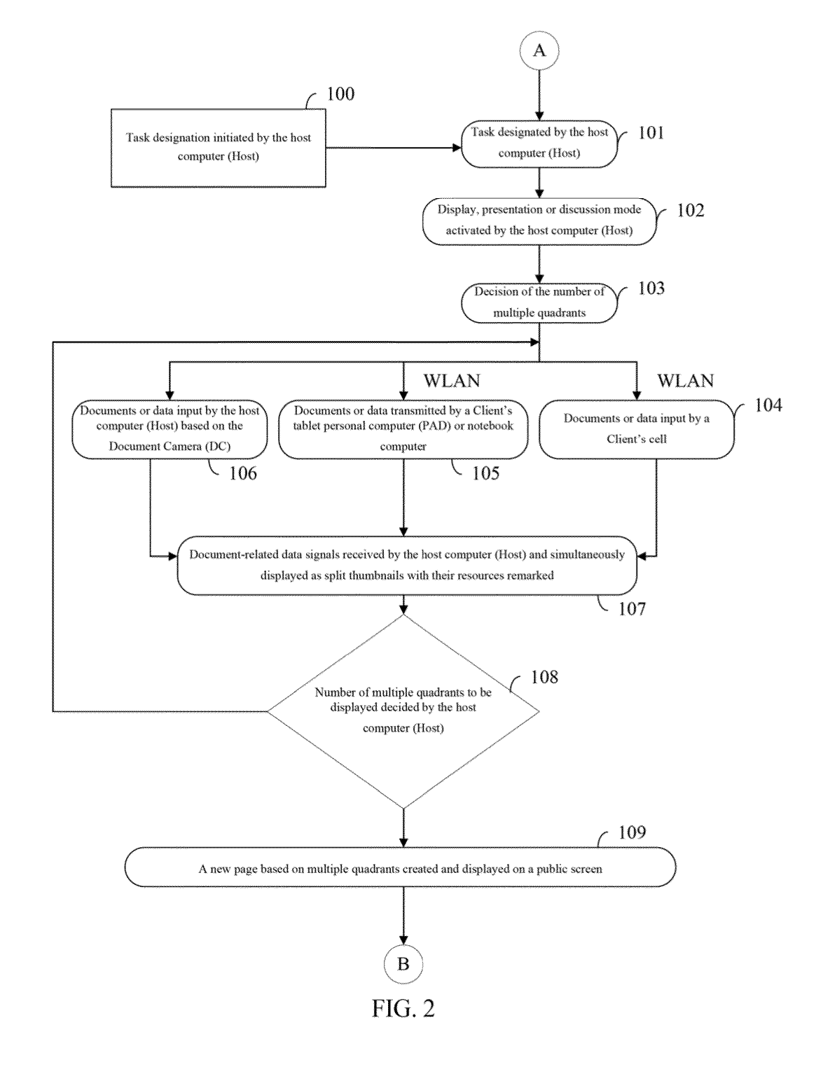

FIG. 3 is a flowchart illustrating zooming in/out of thumbnails in multiple quadrants for the present invention;

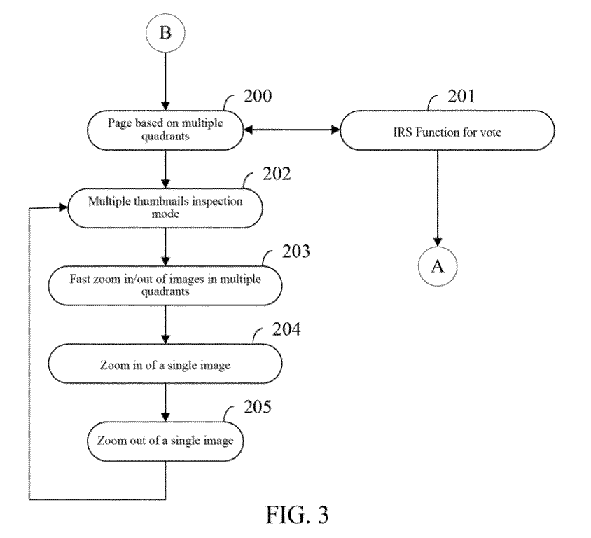

FIG. 4 is a schematic illustration showing the determination of the number of multiple quadrants for the present invention;

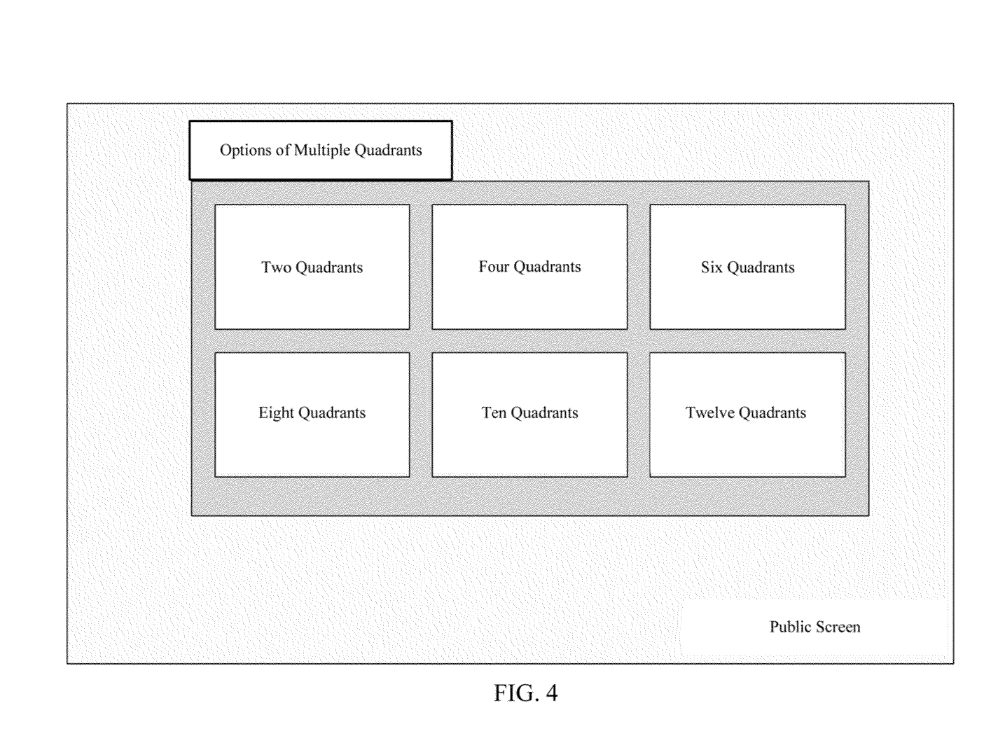

FIG. 5 is a schematic illustration of four quadrants for the present invention;

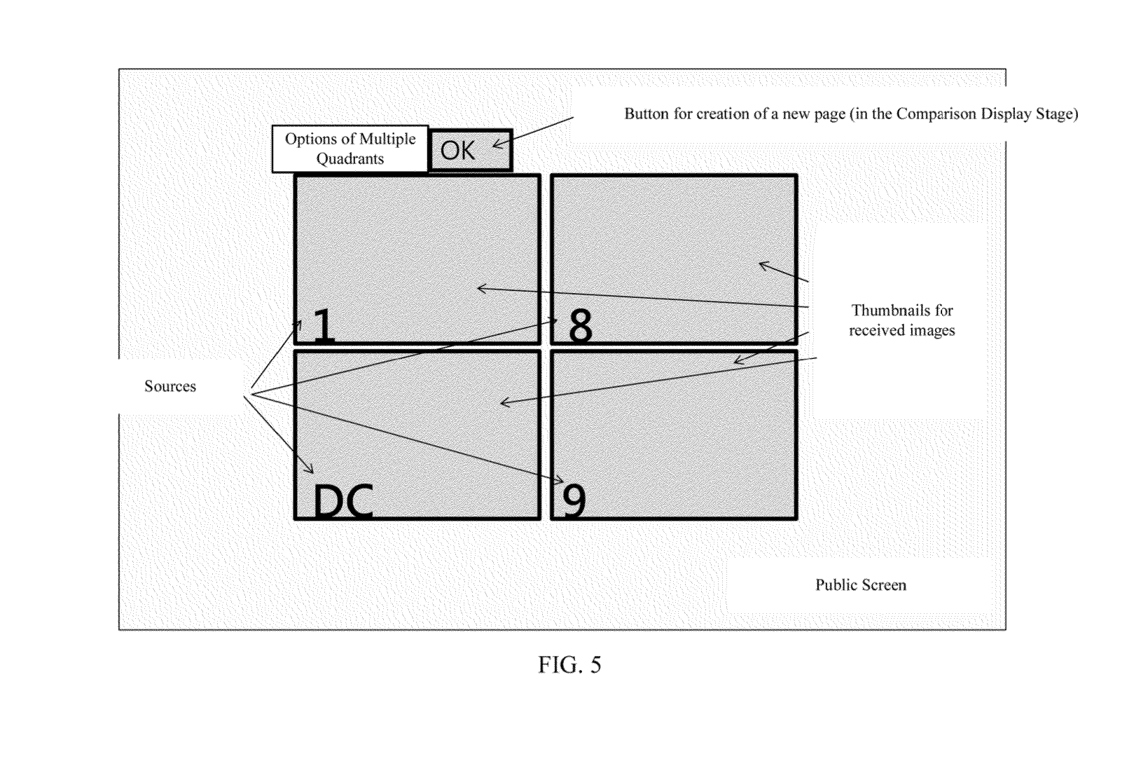

FIG. 6 is a schematic illustration explaining four quadrants for the present invention;

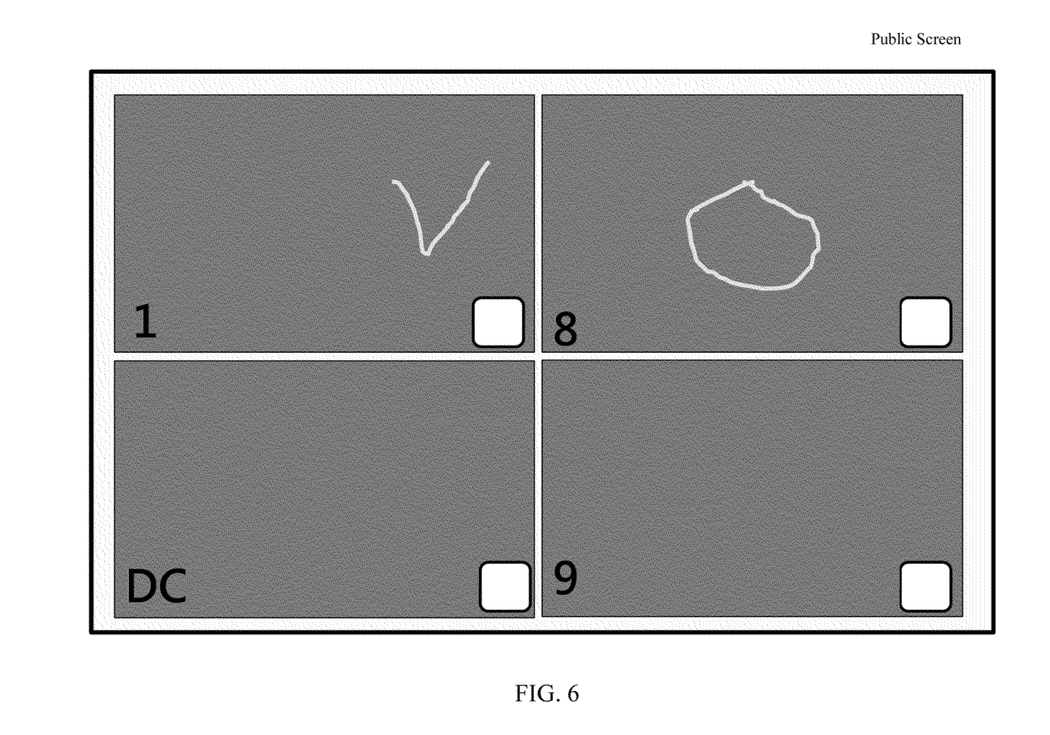

FIG. 7 is a schematic illustration of multiple quadrants for the present invention;

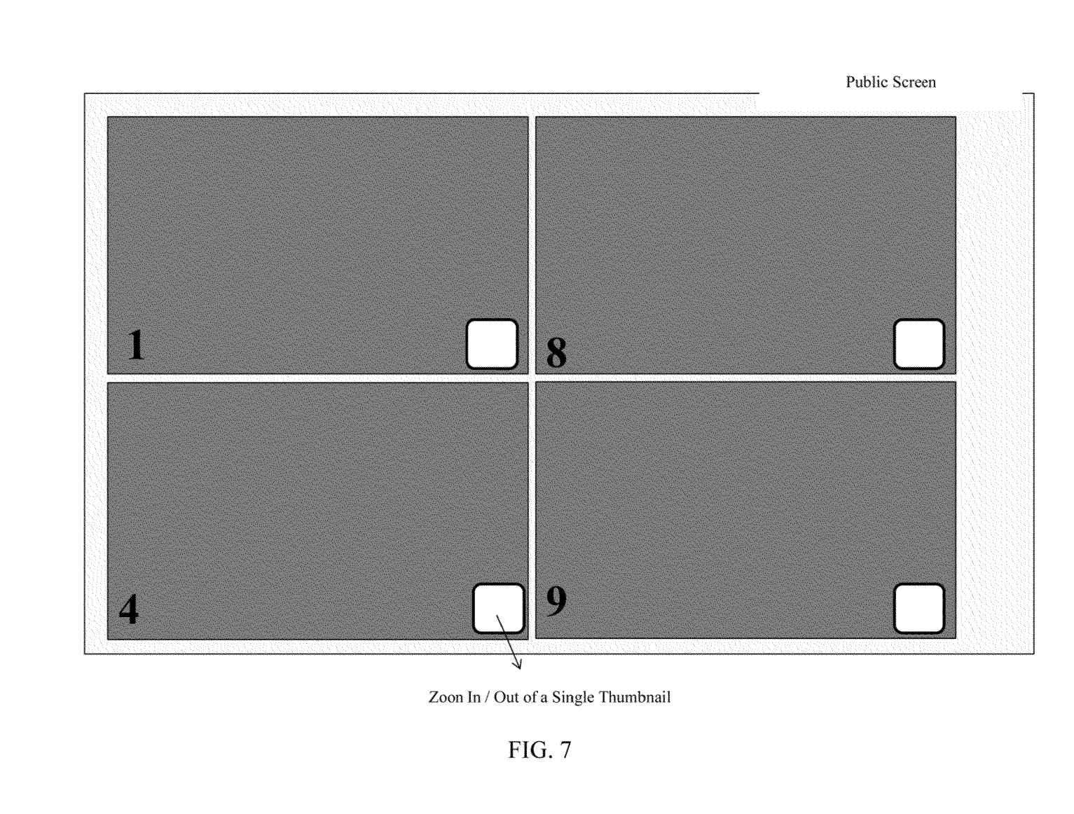

FIG. 8 is a schematic illustration of an enlarged single thumbnail out of multiple quadrants for the present invention; and

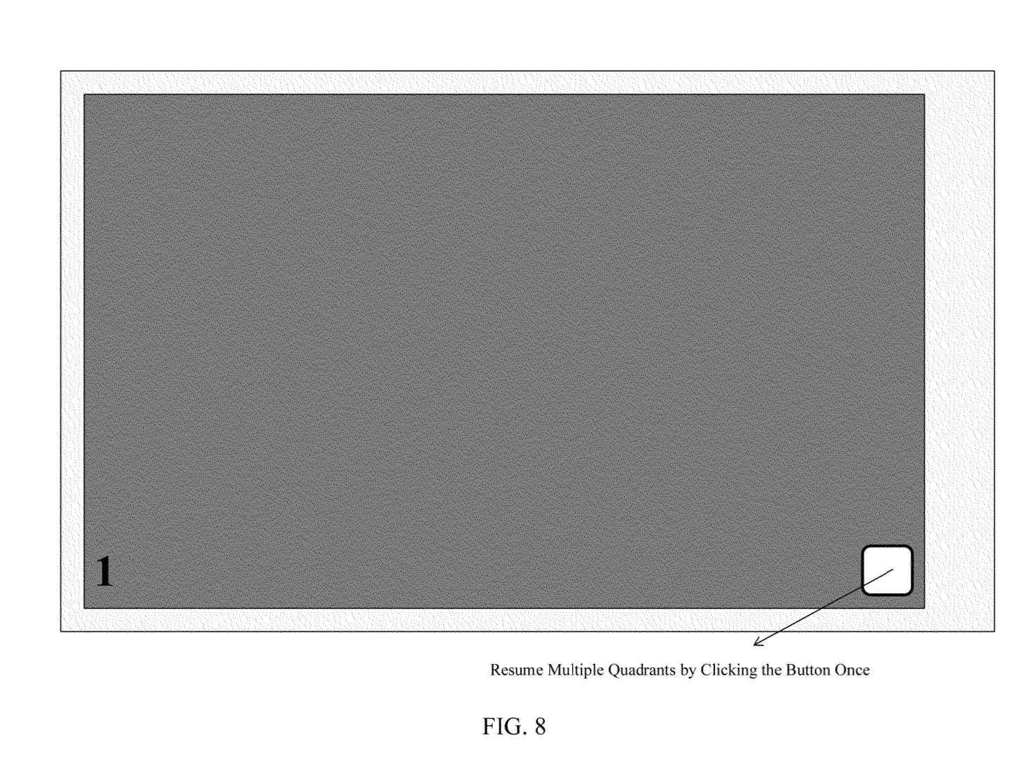

FIG. 9 is a schematic illustration of a vote via multiple quadrants for the present invention.

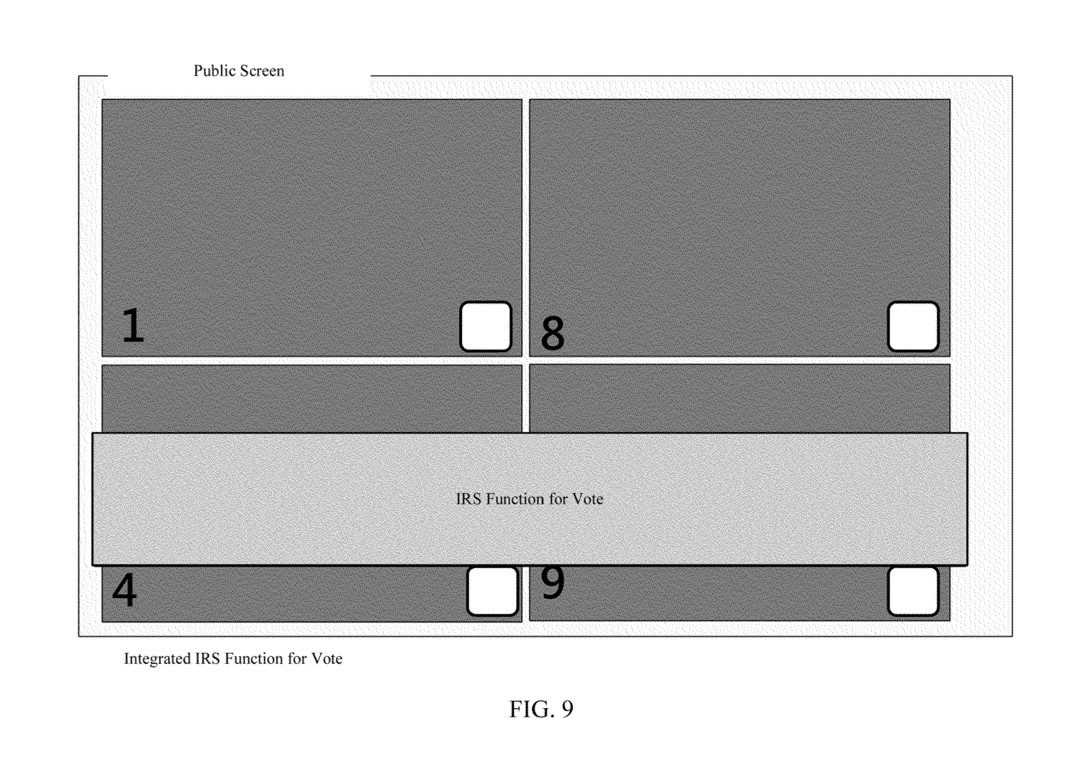

### DESCRIPTION OF REFERENCE CHARACTERS OF IMPORTANT PARTS

1 Scanned document/object

2 Document Camera (DC)

3 Host computer (Host)

4 Public screen

5 Wireless Local Area Network (WLAN)

6 Smartphone

7 Tablet personal computer (PAD)

8 Notebook computer

100˜109 Flowchart for the comparison display system

200˜205 Zoom in/out of a thumbnail out of multiple quadrants

1. A multi-source, multiple document comparison display system for presentation or discussion, comprising:
a document collection stage, wherein the document comparison display system is activated by a host computer (Host), and wherein documents saved in different carriers are transmitted via a cable network or a Wireless Local Area Network to the Host, and wherein the document comparison display system determines a number of quadrants to be arranged via an interface based on the documents received and displays said documents;
a comparison display stage, wherein each document is zoomed out and arranged on a public screen using a thumbnail, and each document can be enlarged and inspected by clicking a control button on the thumbnail corresponding to the desired document.

2. The multi-source, multiple document comparison display system for presentation or discussion according to claim 1, wherein the different carriers are a document camera, tablet personal computer, smartphone, drawing pad, and/or a notebook computer.

3. The multi-source, multiple document comparison display system for presentation or discussion according to claim 2, wherein the Document Camera (DC) provides scanned substantial objects which are transferred to images and delivered to the host computer.

4. The multi-source, multiple document comparison display system for presentation or discussion according to claim 1, wherein the number of quadrants displayed on the public screen are two quadrants, four quadrants, six quadrants, eight quadrants, nine quadrants, ten quadrants, or twelve quadrants.

5. The multi-source, multiple document comparison display system for presentation or discussion according to claim 1, wherein the content of a document or data provides information for some footnotes or comments left on the public screen.

6. The multi-source, multiple document comparison display system for presentation or discussion according to claim 1, wherein a real-time vote can be implemented between the host computer and the different carriers in the comparison display stage.

7. The multi-source, multiple document comparison display system for presentation or discussion according to claim 1, wherein the status for an ongoing vote can be shown in multiple quadrants on the public screen.

8. The multi-source, multiple document comparison display system for presentation or discussion according to claim 1, wherein the thumbnails are arranged in a page based on multiple quadrants.

9. The multi-source, multiple document comparison display system for presentation or discussion according to claim 8, wherein the page based on multiple quadrants comprises at least one image shown on the public screen.

10. The multi-source, multiple document comparison display system for presentation or discussion according to claim 8, wherein the page based on multiple quadrants displays an enlarged single image to be checked.
